(19) United States
(12) Patent Application Publication
(10) Pub. No.: US 2026/0058071 A1
(43) Pub. Date: Feb. 26, 2026

(54) Contactor Device For High Voltage Electrical Systems

(71) Applicant: Sensata Technologies, Inc., Attleboro, MA (US)

(72) Inventors: Tamas Fenyvesi, Ballerup (DK); Thomas Gerjen Hendrik Kouwen, Ojai, CA (US)

(73) Assignee: Sensata Technologies, Inc., Attleboro, MA (US)

(21) Appl. No.: 18/810,079

(22) Filed: Aug. 20, 2024

(51) Int. Cl. H01H 9/10; H01H 36/00; H01M 10/42; H01M 50/583

(52) U.S. Cl. CPC H01H 9/10; H01H 36/00; H01H 2036/0093; H01M 10/425; H01M 2010/4271; H01M 50/583

(57) ABSTRACT

An improved contactor device includes a high voltage switching device, current sensing components, and battery management components that may include a disconnect device. The contactor device may integrate, e.g., into a single device, a number of functionalities conventionally distributed across a number of disparate components and/or facilitate additional functionalities.

### FIELD OF THE TECHNOLOGY

The subject disclosure relates to electrical switching devices, such as contactor devices and electrical fuse devices, and more particularly to improved contactor devices with improved functionality and/or versatility.

### BACKGROUND OF TECHNOLOGY

High voltage electrical systems, such as those present in electric vehicles, generally require a number of features and components for managing, controlling, and/or ensuring safety of aspects of the system. For instance, electrical contactors, e.g., high-voltage DC contactors, are conventionally used to selectively interrupt or complete a circuit to control electrical power to and from a load. Moreover, fuses, e.g., electrical fuses and/or pyrotechnic fuses, are conventionally available and used in electrical systems for overcurrent protection. For example, fuses may be used to prevent short circuits, overloading, and/or permanent damage to an electrical system or a connected electrical device.

Battery-operated high voltage electrical systems, such as electric vehicles, hybrid electric vehicles, and/or the like also conventionally include battery management systems to regulate and/or monitor the operation of batteries during charging and discharging. For example, conventional battery management systems can determine attributes of batteries, such as state-of-charge, state-of-health, and/or the like. Electric vehicles and other high voltage electrical systems can also include a number of additional operating and/or safety features, including but not limited to current measuring devices, e.g., shunt-type and/or hall effect-type devices.

In conventional electric systems, such as electric vehicles, the various components are distributed throughout the system, which can lead to difficulties in assembly, performance, and/or design. Accordingly, there is a need in the art for improved, integrated devices for use in high voltage electrical systems. There also is a need in the art for improved devices that are capable of quickly protecting against short circuits or similar events, have improved current detection, and/or have one or more of reduced complexity, weight, size, and/or cost.

### SUMMARY OF THE TECHNOLOGY

The subject technology relates to improved electrical devices and methods of making and using those devices. In examples, aspects of this disclosure relate to improved switching devices with integrated short circuit disconnect capability, current and/or velocity measuring functionality, and/or battery management means, among other things. For example, aspects of this disclosure may relate to intelligent contactor devices that include switching, fuse, battery management, and current measurement functionality in a single device.

### BRIEF DESCRIPTION OF THE DRAWINGS

So that those having ordinary skill in the art to which the disclosed systems and techniques pertain will more readily understand how to make and use the same, reference may be had to the following drawings.

FIG. 1 is a schematic representation of an electric vehicle including an integrated contactor device, in accordance with aspects of this disclosure.

FIG. 2 is a schematic representation of the integrated contactor device of FIG. 1, in accordance with aspects of this disclosure.

FIG. 3 is a schematic representation of an electrical system incorporating aspects of the integrated contactor device of FIG. 2, specifically demonstrating aspects of electrical connectivity associated with the electrical system, in accordance with aspects of this disclosure.

### DETAILED DESCRIPTION

The subject technology overcomes many of the prior art problems associated with electrical devices. In brief summary, the subject technology provides improved electrical devices including an integrated contactor system that combines the functionalities of a high voltage switching device, a fast disconnect device, aspects of a battery management system, and/or a current measuring device.

As noted above, conventional electrical systems, especially high voltage electrical systems such as in electric vehicles, hybrid electric vehicles, charging stations, and/or the like, rely on a number of disparate components for proper and safe functioning. For instance, electrical systems may require a number of contactors, a number of current sensing elements, fuses, a battery management system, an insulation monitoring device and/or other components. Conventionally, these components are separate components that are configured within the system. Because of the sheer number of components, much cost and effort goes into the design and assembly of these conventional electrical systems. Moreover, electrical systems conventionally have a number of passive components that are connected via wire harness. These connections are prone to failure that can adversely affect the system, including by welding contactors and/or the like. Additionally, conventional systems often are limited in their utility, for example, because each parallel battery pack in a system has conventionally need a separate battery management system for each pack.

Aspects of this disclosure relate to an improved contactor device that is capable of performing a number of functions that have conventionally been distributed across a system. For example, the contactor devices according to this disclosure can integrate one or more of switching, current measuring, weld avoidance, battery management, and/or insulation monitoring functionalities into a single device, e.g., having a single housing.

The contactor devices according to this disclosure may offer a number of benefits over conventional systems. For example, the contactor systems described herein may facilitate both current measurement required for functional safety requirements, as well as current measurement for non-functional safety, such as current detection for determining state of charge, state of health, and/or the like. In some examples, these disparate current measurements may be supported in redundancy and/or without any external sensor. Moreover, current sensing in the contactor system may facilitate weld avoidance and detection locally, e.g., in the contactor that could potentially weld. Aspects of this disclosure can also reduce a number and/or complexity of wire harnesses required in conventional systems.

Without limitation, the devices and techniques described herein may provide improved electrical devices, which may be less complex, may be cheaper to manufacture and/or use, and/or that may have improved safety and/or result in improved system protection, when compared to similar conventional systems. Moreover, while aspects of this disclosure may be particularly useful in certain application, like high voltage automotive systems, including electric vehicles and electric vehicle charging stations, the systems and techniques described herein may be useful with many electrical systems.

Aspects of the disclosure will now be explained in more detail with reference to the Figures.

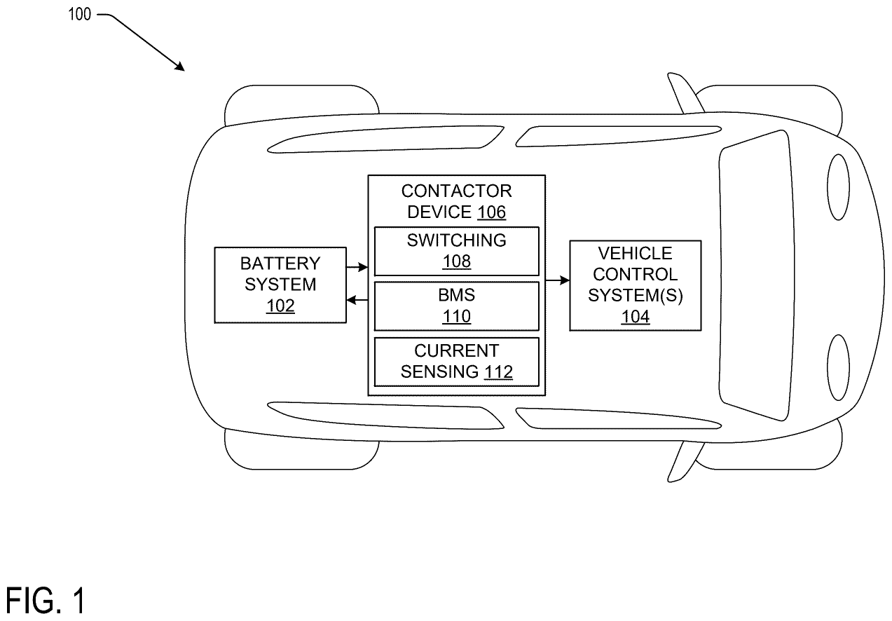

FIG. 1 illustrates a vehicle 100. The vehicle 100 may be any conventional vehicle, such as, for example, a van, a sport utility vehicle, a cross-over vehicle, a truck, a bus, an agricultural vehicle, a construction vehicle, and/or the like. In specific examples of this disclosure, the vehicle 100 may be an electric vehicle (EV), a hybrid electric vehicle (HEV), and/or the like.

FIG. 1 illustrates that the vehicle 100 includes a battery system 102, one or more vehicle control systems 104, and a contactor device 106. In examples, the battery system 102 may comprise one or more battery packs. For instance, a battery pack include a plurality of battery modules or cells, e.g., stacked on or otherwise arranged relative to each other. For example, the battery system 102 can include any number of cells. Without limitation, the battery system 102 can include one or more lithium ion cells or similar battery cells including lithium molybdenum, nickel, cadmium and PB cells, for example. The battery system 102 is generally configured to provide high voltage power to aspects of the vehicle 100, including the vehicle control system(s) 104.

The vehicle control system(s) generally includes any systems that may be configured to receive voltage and/or provide voltage to the battery system 102. For example, the vehicle control system(s) 104 can include one or more actuators that perform functions of the vehicle 100. For instance, the control system(s) 104 may include one or more motor(s). In some examples, the control system(s) 104 comprise or are part of a propulsion system of the vehicle. By way of example and not limitation, the control system(s) 104 may also include one or more of a steering system, a braking system, an active suspension system, related controls and actuators for the forgoing systems, electronics related to supplying power from the battery system 102, and/or any other systems or components that may require power from the battery system 102. In some examples, the vehicle control system(s) 104 can also or alternatively include computing systems, e.g., configured to perform autonomous or semi-autonomous functions at the vehicle 100. Generally, the vehicle control system(s) 104 may be any load that is powered by the battery system 102.

The contactor device 106 is an integrated electrical subsystem that is configured to manage, control, monitor, and/or otherwise interact with the flow of electricity between the battery system 102 and the vehicle control system(s) 104. In examples of this disclosure, the contactor device 106 may be embodied as an integrated high current subsystem that includes components to perform a number of different functionalities. As illustrated in FIG. 1, the contactor device 106 may include a switching component 108, a battery management system 110, and a current sensing component 112.

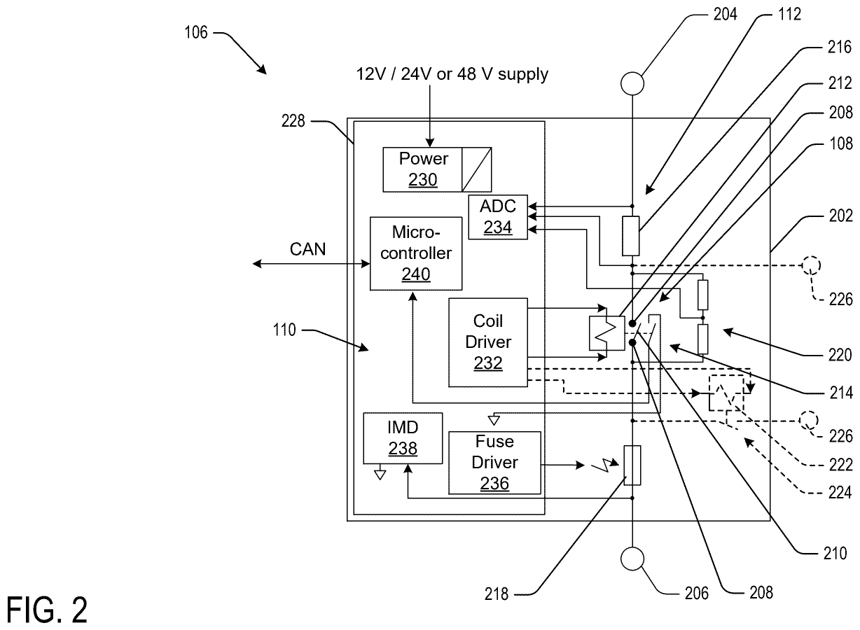

The switching component 108 can perform the operations of, and include components of, a conventional contactor device. For example, the switching component 108 can include functionality to selectively prevent or allow current flow between the battery system 102 and the vehicle control system(s) 104. In examples, the switching component 108 can include a movable contact that is movable between a first position spaced from a first fixed contact electrically connected to the battery system 102 and from a second fixed contact connected to the vehicle control system(s) 104 and a second position contacting the fixed contacts. In at least some examples, the contactor device 106 may also include multiple instances of the switching component 108, e.g., one for use on a power supply side and one for use on a power load side. Additional details of the switching component 108 are detailed further below, with reference to FIG. 2.

The battery management system 110 includes functionality to control and/or monitor aspects of the battery system 102. For example, and as detailed further herein, the battery management system 110 can control charging and/or discharging of individual battery cells comprising the battery system 102.

The current sensing component 112 generally includes functionality to determine a current (and/or a voltage) of electricity flowing through the contactor device 106 (and thus through the vehicle 100). In examples, the current sensing component 112 can include one or more of a resistive shunt, a hall effect sensor, and/or other components. The current sensing component 112 can be configured for monitoring aspects of the electrical system of the vehicle 100 for functional safety of the vehicle, for identifying potential welding of components, and/or for use in quantifying aspects of the battery system 102, such as state of charge, state of health, and/or other aspects of the battery system 102.

Although the contactor device 106 is illustrated as including the switching component 108, the battery management system 110, and the current sensing component 112, as detailed further herein, the contactor device 106 can include additional or different components. For instance, the contactor device 106 can integrate additional functionality associated with the vehicle 100, including but not limited to fuse functionality, weld detection functionality, insulation monitoring functionality, and/or additional functionality. Moreover, although the switching component 108, the battery management system 110, and the current sensing component 112 are illustrated in FIG. 1, these components are provided merely for ease of description and understanding. Functionality that may be described herein as being associated with the switching component 108 may also or alternatively be associated with battery management and/or current sensing. Without limitation, and as will be appreciated from this disclosure, the contactor device 106 is configured to provide an integrated device capable of providing a number of functionalities, regardless of a label given to the systems/components that perform those functions.

FIG. 2 is a schematic representation of the contactor device 106, showing aspects of the contactor device 106 in more detail. As detailed herein, the contactor device 106 may be embodied as an integrated electrical subsystem that is configured to perform a number of disparate functions. In FIG. 2, the reference numerals introduced in FIG. 1 are used to signify the same components. For example, FIG. 2 generally shows the switching component 108, aspects of the battery management system 110, and the current sensing component 112.

FIG. 2 schematically illustrates that the contactor device 106 includes a housing 202 in which the various components detailed further herein are disposed. The housing 202 may comprise a body sized and configured to receive the components described herein. In examples, the housing may be a hermetically sealed housing, although in other examples, the housing 202 may not be sealed. The housing 202 may be made of a non-conductive material, e.g., a polymeric or ceramic material, although other materials may also or alternatively be used.

As also shown in FIG. 2, the contactor device 106 includes a first terminal 204 and a second terminal 206. The terminals 204, 206 are configured to facilitate electrical connection of the battery system 102 and the vehicle control system(s) 104. For example, the first terminal 204 may be coupled to one of the battery system 102 or the vehicle control system(s) 104, and the second terminal 206 may be coupled to the other of the battery system 102 or the vehicle control system(s) 104. The terminals 204, 206 may be embodied as any conductive material, such as copper or the like. And the terminals 204, 206, may take any of a number of conventional shapes or sizes, including but not limited to posts, bars, and/or threaded openings. In examples, at least a portion of the terminals 204, 206 may protrude or extend from the housing 202, e.g., for ready connection of high voltage lines.

FIG. 2 also illustrates that the contact system includes a number of mechanical and electromechanical components. For example, FIG. 2 shows aspects of the switching component 108. As noted above, the switching component 108 can be configured to selectively allow or inhibit high voltage electricity from passing through the contactor device 106. In FIG. 2, the switching component is illustrated schematically as including one or more fixed contacts 208 and a movable contact 210. The switching component 108 is also illustrated as including a coil 212. In examples, the switching component 108 include features of a conventional contactor, such as two fixed contacts and a movable contact movable between a first position electrically coupling the fixed contacts and a second position spaced from the fixed contacts. Although FIG. 2 shows only a single instance of the switching component 108, in other examples multiple instances may be provided. For instance, some conventional electrical systems may include multiple contactors, e.g., a pair of contactors, and the contactor device 106 of the present disclosure may also include multiple switching components. Without limitation, a first instance of the switching component 108 may be provided proximate a power supply side of the contactor device 106 and a second instance of the switching component 108 may be provided proximate a load side of the contactor device 106.

As also illustrated in FIG. 2, the contactor device 106 can include the coil 212, e.g., a DC coil. As in some conventional contactors, the coil 212 may be selectively energized/deenergized to control movement of an actuator assembly associated with the movable contact 210. FIG. 2 also illustrates an auxiliary coil 214 associated with movable contact 210 and the coil 212. For example, the auxiliary coil 214 may be provided to verify a position of the movable contact 210.

FIG. 2 also shows a sensing element 216 disposed in the housing 202. As illustrated, the sensing element 216 may be disposed between the first terminal 204 and the switching component 108, e.g., such that the high voltage passes through sensing element 216 when the switching component 108 is closed. In some examples, the sensing element 216 can include a shunt, e.g., a resistive shunt. For example, the sensing element can be a low resistance shunt across which changes in voltage can be measured. In other examples, the sensing element 216 can also or alternatively include a hall effect element.

The contactor device 106 according to aspects of this disclosure also is illustrated as including a fuse element 218. The fuse element 218 is illustrated as being disposed between the switching component 108 and the second terminal 206. The fuse element 218 may be configured to be actuated to prevent, permanently in some examples, the flow of current through the contactor device 106. In examples, the fuse element 218 can be a pyrotechnic fuse that includes a pyrotechnic actuator that, when detonated, permanently destroys an aspect of the path through which high voltage electricity flows. Although illustrated as being separate from aspects of the switching component 108, in other examples the fuse element 218 may be integrated with the switching component 108. Without limitation, detonation of the fuse element 218 may cause the movable contact 210 to be permanently moved away from the fixed contacts 208.

The contactor device 106 can also include additional components. For example, FIG. 2 illustrates one or more resistive elements 220 disposed in parallel with the switching element 108. For example, the resistive element(s) 220 may facilitate measurement of a voltage drop across the movable contact 210, e.g., when the movable contact 210 contacts the fixed contacts 208 and electricity flows through the contactor device 106.

The contactor device 106 can also, optionally, include an auxiliary coil 222 and an auxiliary switch 224 (e.g., an auxiliary contactor or relay). The auxiliary coil 222 and/or the auxiliary switch 224 may be associated with optional auxiliary terminals 226. In examples, the auxiliary coil 222 and the auxiliary switch 224 may be associated with a pre-charge component, which may be embodied as a pre-charge circuit, a pre-charge switch, or the like. In some examples, the pre-charge component can include circuitry that may be configured with limited dissipation. For instance, the pre-charge circuitry may include a switched mode converter, which may have continuous current regulation. In other examples, the auxiliary coil 222 and the auxiliary switch 224 may comprise a pre-charge contactor or pre-charge switch. In at least some examples, the pre-charge component may be a semi-conductor based switch.

FIG. 2 also illustrates that the contactor device 106 includes a number of electrical components including a circuit board 228 disposed in the housing 202. For example, the circuit board 228 may be a printed circuit board, such as a flexible printed circuit board, carrying a number of electrical components and connections between and among those components. As detailed further herein, the components on the circuit board 228 can be configured to perform a number of functions including functions associated with the switching component 108, the sensing element 216 and/or the fuse element 218 just described, e.g., to integrate functions associated with those and/or other elements into a single device. For ease of illustration and clarity, connections between the various components on the circuit board 228 are omitted, although a person having ordinary skill in the art will appreciate that Although the circuit board 228 is illustrated as a single circuit board, in other examples the circuit board 228 can include two or more circuit boards, e.g., with the various components distributed across the multiple boards.

In the example of FIG. 2, the circuit board 228 is illustrated as including a power supply 230. The power supply 230 is generally provided to power the various components on the circuit board 228, as detailed further herein. The power supply 230 may be a low voltage power supply. In the illustrated example, the power supply 230 receives power from an external source, such as a 12V/24V or 48V supply. In other examples, the power supply 230 may be a battery coupled to the circuit board 228.

The circuit board 228 also is illustrated as including a coil driver 232. In examples, the coil driver 232 can include circuitry to drive the coil 212. For example, the coil driver 232 may be configured to selectively energize the coil 212 to correspondingly drive the movable contact 210. As also illustrated, the coil driver 232 can also include functionality to drive the auxiliary coil 222, e.g., when provided.

The circuit board 228 also is illustrated as including an AC/DC converter 234 (herein also referred to as “the ADC 234”). The ADC 234 may be a portion of the current sensing component 112. For instance, and as illustrated, the ADC 234 may be associated with the sensing element 216. More specifically, the ADC 234 may facilitate measurement of a voltage across the resistive shunt, e.g., to determine whether the appropriate current is flowing between the terminals 204, 206. Thus, in examples, the ADC 234 can facilitate current measurement according to functional safety requirement for electrical systems, like the vehicle 100. As will be appreciated, then, the contactor device 106, in addition to providing switching, as in a conventional contactor, can also provide current measurement, as required for safe operation. In conventional electrical systems, current measurement is performed with a device, e.g., a resistive shunt, electrically connected to, but physically separate from, the contactor. These conventional arrangements may require additional design and complex assembly, whereas the contactor device 106 provides both (and additional) functionalities in the housing 202.

As also illustrated in FIG. 2, the ADC 234 may be associated with the one or more resistive elements 220 configured across the switching element 108. For instance, the ADC 234 can also cooperate with the resistive element(s) 220 to determine a voltage drop across the movable contact 210. For example, this voltage drop can be used to confirm a state (e.g., open/closed state) of the movable contact 210. Thus, in some examples, the ADC 234 can facilitate current measurement as required by functional safety requirements, but also for other operational functions. For instances, these measurements can also protect the fixed contacts 208 and the movable contact 210 from welding together, e.g., in the event of an increased current. Also in examples, the current measurement and the voltage drop can be used to evaluate a resistance and/or a surface quality at the contact of the movable contact 210 and the fixed contacts 208.

The current measurements facilitated by the ADC 234, including those measurement made with the resistive elements(s) 220 may also be used to monitor, maintain, and/or control the battery system 102. For example, the voltage drop across the movable contact 210 can be used for detecting an end of a pre-charge operation and/or to facilitate safe joining with parallel battery packs of the battery system 102. Moreover, the measurements can be used to determine health metrics associated with the battery system 102, including but not limited to state of charge, state of health, and/or the like. As will be appreciated from the foregoing, the inclusion of the current sensing component 112 including the ADC 234 in the contactor device 106 provides improvements over conventional systems. Because the integrated system of examples of this disclosure can provide current sensing for functional safety requirements and for battery monitoring (e.g., not required for functional safety), the contactor device 106 may facilitate higher current rating specifications than conventional systems, but in a single device that may be substantially the same size as a conventional contactor and/or at a reduced cost relative the conventional system that requires additional connections (e.g., bus bars) and/or the like.

The contactor device 106 of FIG. 2 also is illustrated as including a fuse driver 236. The fuse driver 236 may be circuitry that coordinates operation of the fuse 218. For example, when the fuse 218 is a pyrotechnic fuse, the fuse driver 236 may be a pyrotechnic driver. In this example, the fuse driver 236 may be configured to selectively generate a signal to cause a pyrotechnic initiator, e.g., a detonator, associated with the fuse 218 to detonate. For example, the fuse driver 236 may be configured to generate the signal in response to receiving an indication that a current through the contactor device 106 exceeds a threshold current, in response to a short circuit, in response to a user instruction, and/or in response to some other event.

The inclusion of the fuse 218 and the fuse driver 236 provides further functionality of the contactor device 106. In conventional arrangements, fuses are often provided as components separate from a contactor and/or a current measurement element. These distributed systems require additional assembly, design considerations, and/or cost. Moreover, because the current measurement components are remote from the fuse in these conventional arrangements, wiring harnesses and/or other connection means are required. However, in examples of this disclosure, by integrating these components into a single device, e.g., onto the circuit board 228, superfluous wiring, bus bar connections, and/or the like can be eliminated.

The contactor device 106 can also include additional functionality. For instance, and as illustrated in FIG. 2, the circuit board 228 can also comprise an insulation monitoring component 238 (hereinafter, “the IMD 238”). The IMD 238 can include functionality to monitor an isolation resistance between the power system, e.g., the current flowing through the contactor device 106 and ground, e.g., the chassis of the vehicle 100. The IMD 238 may include functionality to detect resistive leakage and/or capacitively stored energy. In some examples, the IMD 238 may be configured to detect all sources of leakage, including multiple, simultaneous symmetrical and asymmetrical faults, as well as resistive paths between the chassis and points in the battery system 102 with the same potential as the chassis. In examples, the IMD 238 may comprise one element of the battery management system 110. Proximity of the IMD 238 to other aspects of the contactor device 106 can ensure that when faults are identified by the IMD 238, appropriate action, such as triggering of the fuse 218 via the fuse driver 236 can be performed quickly and reliably, thereby enhancing safety outcomes, and ensuring functional safety requirements.

The contactor device 106 also is illustrated as including a microcontroller 240. In examples, the microcontroller 240 can include functionality to control aspects of the components just described. For example, the microcontroller 240 can include functionality to generate and transmit signals to the coil driver 232, e.g., to selectively open/close the switching component 108, and/or to the fuse driver 236, e.g., to blow the fuse 218. The microcontroller 240 can also include functionality to receive signals, e.g., signals from the ADC 234 representative of current measurements and/or voltage measurement, and/or signals from the IMD 238 representative of isolation and/or leakage current. The microcontroller 240 can also include functionality to process the received signals, e.g., to determine, based on received signals and/or other factors, to drive the coil driver 232 and/or to blow the fuse 218 via the fuse driver 236. These functions described may be associated with functional safety requirements, e.g., to ensure safety in the electrical system.

Also in examples, the microcontroller 240 can include functionality to perform additional battery management functions, e.g., as the BMS 110. For instance, the microcontroller 240 can receive signals from and/or transmit signals to a battery source, such as the battery system 102. In the example of FIG. 2, the microcontroller 240 is illustrated as being in communication with a controller area network (CAN). In examples, the CAN facilitates communication between the microcontroller 240 and the battery system 102.

Using the CAN, the microcontroller 240 can send signals to and/or receive signals from the battery system 102, e.g., to control and/or monitor aspects of the battery system 102. For example, the microcontroller 240 can function as a controller or a control unit (e.g., a microcontroller unit, MCU) for a battery management system. Without limitation, the microcontroller 240 can include functionality to determine a state of charge, a state of health, and/or other aspects of the battery system 102 based on information from the battery system 102, information from the ADC 234, and/or other information. The microcontroller can generally be configured to perform any operations associated with the switching component 108, the battery management system 110, and/or the current sensing component 112, and/or any other aspects of the contactor device 106 described herein.

As will be appreciated from the foregoing, the contactor device 106 according to aspects of this disclosure can incorporate, e.g., in a single device, a number of functionalities typically distributed across numerous components. This may reduce labor associated with fabrication of electrical systems and/or material, e.g., by eliminating a number of connections required in conventional systems. The contactor device 106 can also facilitate a number of additional functionalities. For instance, in some examples, and as noted above, an integrated active shunt's amp (e.g., as a part of the sensing element 216) and the ADC 234 can be used to measure a voltage across the switching component 108 for detecting an end of pre-charge. This functionality may protect the switching component 108 without relying on a conventional battery management system. Moreover, the ADC 234 may be a low offset amplified that can monitor the voltage drop across the switching component 108 in the closed state. In examples, the microcontroller 240 can be configured to determine this voltage drop. The microcontroller 240 can also, or alternatively, but configured to use the voltage drop and current measurements to evaluate a contact resistance and/or a contact surface quality of the switching component 108. As a result of this functionality, the contactor device 106 can achieve higher than usual current rating specifications, but at a reduce size and/or cost.

In other examples, the contactor device 106 may be used to modulate a current of the coil 212, e.g., by the coil driver 232. For example, the microcontroller 240 may receive information from an auxiliary contact associated with the switching component 108. The auxiliary contact may be used to determine a current requirement required for opening the switching component 108. For example, the contactor device 106 may perform as an economizer, but using a single coil, e.g., the coil 212. The contactor device 106 can modulate coil current if increased pull force is needed, e.g., at extremely high pass current, in high G in a critical direction events, e.g., bumps, and/or the like. Other functionalities also will be appreciated by those having ordinary skill in the art, with the benefit of this disclosure.

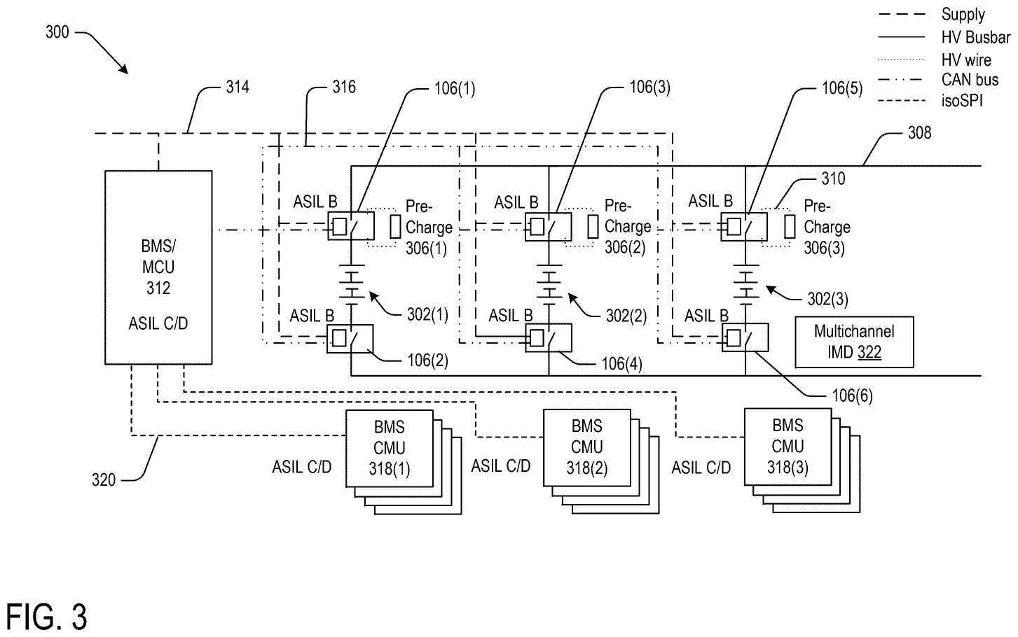

FIG. 3 is a schematic representation showing additional aspects of an electrical system 300, which may be a high voltage electrical system such as the system on the vehicle 100 of FIG. 1. In more detail, FIG. 3 shows a first battery pack 302(1), a second battery pack 302(2), and a third battery pack 302(3) (collectively referred to herein as “the battery packs 302”), arranged in parallel. The inclusion of three battery packs 302 is for example only; more or fewer battery packs 302 may be present in other instances. Without limitation, the battery packs 302 may comprise the battery system 102 of FIG. 1, discussed above.

As also illustrated in FIG. 3, two instances of the contactor device 106 according to this disclosure are associated with each of the battery packs. For example, a first contactor device 106(1) and a second contactor device 106(2) are disposed at positive and negative sides of the first battery pack 302(1), a third contactor device 106(3) and a fourth contactor device 106(4) are disposed at positive and negative sides of the second battery pack 302(2), and a fifth contactor device 106(5) and a sixth contactor device 106(6) are disposed at positive and negative sides of the third battery pack 302(3). As noted above, more or fewer of the battery packs 302 may be used, and, correspondingly, more or fewer instances of the contactor device 106 may be provided. FIG. 3 also shows that the first contactor device 106(1) has associated first pre-charge circuitry 306(1), the third contactor device 106(3) has associated second pre-charge circuity 306(2), and the fifth contactor device 10 (5) has associated third pre-charge circuitry 306(3). Herein, one or more of the first, second, and/or third pre-charge circuitry 306(1), 306(2), 306(3) may be referred to as “the pre-charge circuitry 306.” In examples, the pre-charge circuitry 306 may comprise the auxiliary coil 222, the auxiliary switch 224, and/or the auxiliary terminals 226 discussed above in connection with FIG. 2. In other examples, the pre-charge circuitry 306 may comprise a pre-charge contactor.

As detailed herein, aspects of this disclosure may provide a simplified system that is easier to assemble, design, and/or use. For example, aspects of this disclosure may include reducing a number of electrical connections, such as wire harness connections, between and among components used to monitor and/or control an electrical system. As illustrated in FIG. 3, each of the contactor systems 104 may be coupled to the associated battery packs 302 and/or to each other via a busbar 308, e.g., a high voltage busbar. As described above, the unique contactor systems 104 of this disclosure include a number of functionalities that have previously been distributed throughout an electrical system, e.g., each requiring a separate connection and/or control system. As also shown, the pre-charge circuitry may be coupled via a wired connection, e.g., using a high voltage wire 310.

As also shown in FIG. 3, the contactor systems are then coupled to a control unit 312 (MCU 312) via only a power supply line 314 and a CAN bus 316. The power supply line 314 may correspond to the power supply shown in FIG. 2 supplying power to the power supply 230, and/or the CAN bus 316 may correspond to the CAN connection to the microcontroller 240 in FIG. 2. As will be appreciated, then, in aspects of this disclosure, each of the contactor systems 104 can be coupled to a high voltage line, e.g., via a bus bar, and then to the MCU 312 via a wire harness that may include only the power supply line 314 and the CAN bus 316. This connectivity scheme greatly reduces connections compared to conventional systems, thereby reducing labor required to build the system 300 and/or reducing points of failure. Moreover, components that are connected via wire harness may be prone to failures that can weld contactors.

The MCU 312 may configured to perform operations associate with a battery management system. For ease of illustration, the MCU 312 is illustrated as being separate from the contactor systems 104, although in some examples, aspects of the MCU 312 can be integrated into one or more of the contactor systems 104, generally as discussed herein. In the example of FIG. 3, the MCU 312 also communicates with a first cell monitoring unit (CMU) 318(1), a second CMU 318(2), and a third CMU 318(3) (collectively, referred to herein as “the CMUs 318”). In the arrangement of FIG. 3, the first CMU 318(1) may be associated with the first battery pack 302(1), the second CMU 318(2) may be associated with the second battery pack 302(2), and the third CMU 318(3) may be associated with the third battery pack 302(3). This is for example only, as other schemes may be used. As shown, the MCU 312 may be coupled to the CMUs 318 via an ISO serial peripheral interface (isoSPI) 320. In examples, the MCU 312 can support any number of CMUs 318, and/or each of the CMUs 318 may have capability to monitor up to ten or more voltage channels and/or temperature channels.

FIG. 3 also illustrates that the electrical system 300 can include a multichannel insulation monitoring device 322 (IMD 322). The IMD 322 may be in addition to, or instead of, the IMD 238 integrated into the contactor device 106, detailed above.

As illustrated in FIG. 3, the electrical system 300 can provide improved safety outcomes and/or meet rigorous functional safety requirements. In examples, the MCU 312 and the CMUs 318 may be ASIL (Automotive Safety Integrity Level) C or D rated. Each of the contactor systems 104 may be ASIL B rated.

While the subject technology has been described with respect to preferred embodiments, those skilled in the art will readily appreciate that various changes and/or modifications can be made to the subject technology without departing from the spirit or scope of the subject technology. For example, each claim may depend from any or all claims in a multiple dependent manner even though such has not been originally claimed.

What is claimed is:

1. A contactor device configured for electrical attachment to a high voltage system, the contactor device comprising:
a housing;
a switching device comprising a first fixed contact, a second fixed contact, and at least one movable contact, the movable contact being movable relative to the first fixed contact and the second fixed contact between a closed position that electrically connects the first fixed contact and the second fixed contact and an open position that electrically separates the first fixed contact from the second fixed contact;
a coil disposed within the housing and configured to move the movable contact between the closed position and the open position; and
current sensing components disposed within the housing and configured to measure a current supplied to or passed from the switching device.

2. The contactor device of claim 1, wherein the current sensing components comprise an analog-to-digital converter.

3. The contactor device of claim 2, wherein the current sensing components further comprise a resistive shunt electrically connected to at least one of the first fixed contact or the second fixed contact.

4. The contactor device of claim 1, wherein the current sensing components comprise a hall effect sensor.

5. The contactor device of claim 1, further comprising:
one or more resistors configured in parallel with the movable contact and coupled to an analog-to-digital converter, the analog-to-digital converter and the one or more resistors being configured to measure a voltage drop across the switching device.

6. The contactor device of claim 1, further comprising:
an insulation monitoring device disposed in the housing.

7. The contactor device of claim 6, wherein the insulation monitoring device is configured to monitor an isolation resistance between the high voltage system and a vehicle chassis.

8. The contactor device of claim 1, further comprising a fuse disposed within the housing.

9. The contactor device of claim 8, wherein the fuse is a pyrotechnic fuse.

10. The contactor device of claim 1, further comprising:
a microcontroller disposed in the housing, the microcontroller communicating with a battery management system associated with one or more batteries coupled to the contactor device, with a coil driver associated with the coil, and with the current sensing components.

11. The contactor device of claim 1, further comprising a pre-charge component comprising an auxiliary switch and an auxiliary coil associated with the auxiliary switch.

12. An electrical system comprising:
one or more batteries; and
a contactor device coupled to the one or more batteries, the contactor device comprising:
a housing;
a switching device disposed within the housing, the switching device comprising a first fixed contact, a second fixed contact, and at least one movable contact, the movable contact being movable relative to the first fixed contact and the second fixed contact between a closed position that electrically connects the first fixed contact and the second fixed contact and an open position that electrically separates the first fixed contact from the second fixed contact;
a switching coil disposed within the housing and configured to move the movable contact between the closed position and the open position;
current sensing components disposed within the housing and configured to measure a current supplied to or passed from the switching device; and
a fuse disposed within the housing and configured to prevent current flow through the contactor device in response to an event.

13. The electric system of claim 12, further comprising a battery management system communicating with the contactor device.

14. The electrical system of claim 13, wherein the battery management system comprises a control unit and one or more cell monitoring units associated with the one or more batteries.

15. The electric system of claim 12, wherein the contactor device further comprises a microcontroller configured to receive data from the current sensing components and to generate signals to at least one of operate a switching coil driver to cause the switching coil to change a state of the switching device or operate a fuse driver associated with the fuse.

16. The electrical system of claim 12, wherein the current sensing components comprise an analog-to-digital converter.

17. The electrical system of claim 16, wherein the current sensing components further comprise a resistive shunt electrically connected to at least one of the first fixed contact or the second fixed contact.

18. The electrical system of claim 12, further comprising:
one or more resistors configured in parallel with the movable contact and coupled to an analog-to-digital converter, the analog-to-digital converter and the one or more resistors being configured to measure a voltage drop across the switching device.

19. The electrical system of claim 12, further comprising a controller configured to determine at least one of an end of pre-charge of a battery of the one or more batteries or joining of the one or more batteries to a parallel pack system based at least in part on the voltage drop.

20. The electrical system of claim 19, wherein the controller is further configured to determine at least one of a contact resistance or a contact surface quality of a contact interface of the movable contact with at least one of first fixed contact or the second fixed contact.
